(19) United States
(12) Patent Application Publication
(10) Pub. No.: US 2009/0295139 A1
(43) Pub. Date: Dec. 3, 2009

(54) Disposable news and advertisement dissemination device for a food or beverage establishment

(76) Inventor: Maximiliano Luis Russo, Miramar, FL (US)

Correspondence Address: RUBEN ALCOBA, ESQ., 3399 NW 72 AVENUE, SUITE211, MIAMI, FL, 33122, US

(21) Appl. No.: 12/156,099

(22) Filed: May 28, 2008

(51) Int. Cl. G06Q 30/00; B42D 15/00; B42D 7/00

(52) U.S. Cl. 283/56; 705/14.5

(57) ABSTRACT

A disposable news and advertisement dissemination device for a food or beverage establishment comprising a disposable sheet material, having an upper surface portion and an under surface portion with a first indicia means and a second indicia means disposed thereon, whereby the first indicia means further comprises a plurality of cells containing advertisements and the second indicia means comprises a plurality of news information articles specifically targeted to the demographic profile of a restaurant's patronage. As sufficient revenue can be generated from the sales of the advertisements appearing on the first indicia means, a restaurant establishment can obtain the advertisement dissemination device at no cost to the restaurant establishment.

### BACKGROUND

The present invention is a disposable news and advertisement dissemination device for a food or beverage establishment that delivers news information and advertisements to restaurant patrons at no cost to the restaurant establishment thereby reducing a restaurateur's operating costs.

The inventor conceived the present invention after frequenting several restaurants and noticing that patron's enjoy reading the newspaper or other sources of news information while they eat or while they are waiting for their food to be served; however, not all patrons carry the necessary change to purchase a newspaper or other source of news information and restaurant establishments often lack a sufficient number of copies of newspapers or other news sources for each patron to enjoy while they eat or wait for their food.

Newspapers and other sources of news information often contain information the reader does not find interesting and as such, it is common practice to skip articles or entire sections of such publications. When restaurateurs are financially responsible for providing the newspaper or other source of news information to its patrons, the skipping of articles or sections of the publications by its patrons has a quantifiable cost associated with it, i.e. the restaurateur is paying for the entire publication and any portion not read is effectively money wasted.

In order to address this problem, the inventor invented the present invention. The present invention comprises a disposable sheet material, having an upper surface portion and an under surface portion each having a first indicia means and a second indicia means disposed thereon, whereby the first indicia means further comprises a plurality of cells containing advertisements and the second indicia means comprises a plurality of news information articles specifically targeted to the demographic profile of a restaurant's patronage.

As the disposable sheet is preferably made of paper, it serves as placemat type protective table setting while at the same time providing restaurant patrons a source of news information at no cost to the restaurant establishment.

Specifically, the first indicia means further comprises a plurality of cells containing advertisements for other businesses, preferably businesses orientated to the demographic profile of the restaurant patrons, whereby each business pays a fee to have its advertisement appear on the first indicia means. As sufficient revenue can be generated from the sales of the advertisements appearing on the first indicia means, a restaurant establishment can obtain the advertisement dissemination device at no cost to the restaurant establishment.

After the present invention is implemented in a restaurant establishment, the restaurateur will realize a reduced operating cost by eliminating the cost of providing news publications and providing placemat type protective table settings to its patrons.

An objective of the present invention is to provide a device that will deliver a source of news information to restaurant patrons at no cost to the restaurateur.

Another objective of the present invention is to provide a device that will deliver a particular source of news information to a targeted demographic profile.

Another objective of the present invention is to provide a disposable device that will deliver news information that is updated periodically.

Yet a further objective of the present invention is to provide a device that will reduce the costs of operating a restaurant establishment.

For the foregoing reasons there exists a need for a disposable news and advertisement dissemination device that delivers targeted news information and advertisements to a particular demographic profile at no cost to the restaurant establishment while at the same time reducing the restaurateur's operating costs.

### SUMMARY

The present invention comprises a disposable sheet material, having an upper surface portion and an under surface portion with a first indicia means and a second indicia means disposed thereon, whereby the first indicia means further comprises a plurality of cells containing advertisements and the second indicia means comprises a plurality of news information articles specifically targeted to the demographic profile of a restaurant's patronage.

As sufficient revenue can be generated from the sales of the advertisements appearing on the first indicia means, a restaurant establishment can obtain the advertisement dissemination device at no cost to the restaurant establishment.

### DRAWINGS

These and other features, aspects, and advantages of the present invention will become better understood with regard to the following description, appended claims and drawings where:

FIG. 1 is a top plan view of one embodiment of the present invention; and

FIG. 2 is a bottom plan view of one embodiment of the present invention.

### DESCRIPTION

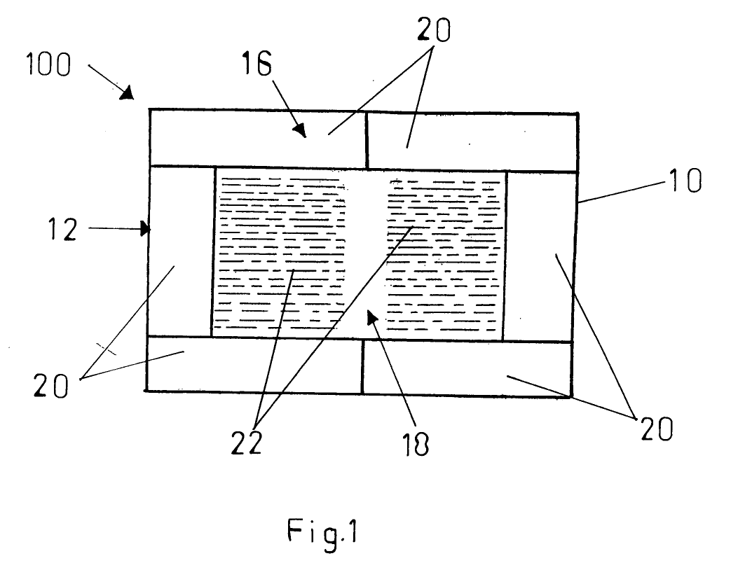

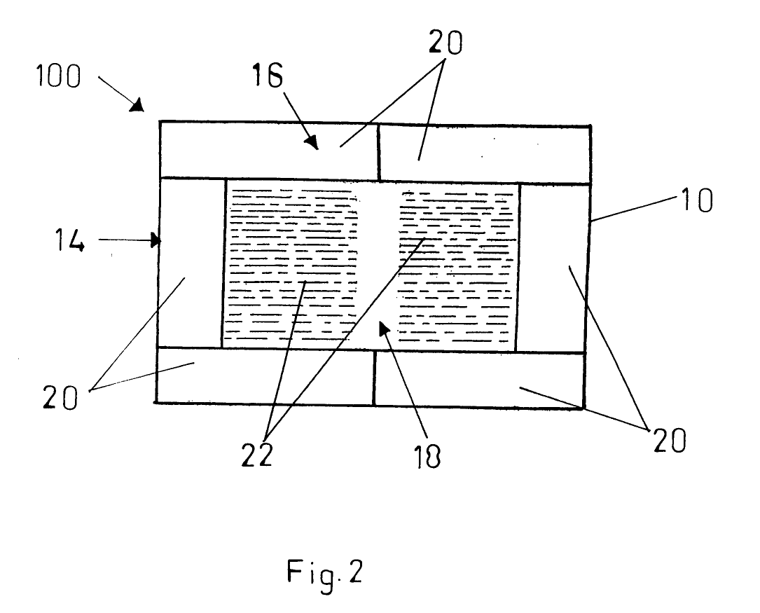

As shown in FIGS. 1 and 2, a disposable news and advertisement dissemination device for a food or beverage establishment 100 comprising a disposable sheet material 10, having an upper surface portion 12 and an under surface portion 14 each having a first indicia means 16 and a second indicia means 18 disposed thereon, whereby the first indicia means 16 further comprises a plurality of cells 20 containing advertisements and the second indicia means 18 comprises a plurality of cells 22 containing news information articles specifically targeted to the demographic profile of a restaurant's patronage.

The first indicia means 16 is disposed along at least one peripheral edge of the sheet material 10 defining a border or partial border for said sheet material 10 and the second indicia means 18 is disposed on the upper surface portion 12 and under surface portion 14 of the sheet material 10 so that the second indicia means 18 is adjacent to the border or partial border defined by the first indicia means 16.

In operation, the disposable news and advertisement dissemination device 100 uses a method of disseminating news and advertisements to restaurant patrons comprising the steps of (a) researching relevant news data that is targeted to a certain demographic profile; (b) disposing said data upon the second indicia means 18 of the disposable news and advertisement dissemination device 100; (c) obtaining sponsors to place advertisements within the disposable news and advertisement dissemination device 100; (d) disposing said advertisements upon the first indicia means 16 of the disposable news and advertisement dissemination device 100; (e) delivering the disposable news and advertisement dissemination device 100 to a restaurateur; (f) placing the disposable news and advertisement dissemination device 100 at each table setting of a food or beverage establishment.

As can be see in FIGS. 1 and 2, the disposable news and advertisement dissemination device 100 has an upper surface section 12 and an under surface section 14 each having a first indicia means 16 further comprising a plurality of cells 20. The plurality of cells 20 might contain designs, alphanumeric information, or other information relating to local business establishments.

As can be see in FIGS. 1 and 2, the disposable news and advertisement dissemination device 100 has an upper surface section 12 and an under surface section 14 each having a second indicia means 18 further comprising a plurality of cells 22. The plurality of cells 22 might contain alphanumeric information in the form of news information articles on a given topic.

The advertising information and news information that appears in first indicia means 14 and second indicia means 16 might be specifically targeted to the demographic profile of a particular food or beverage establishment's patrons and is updated periodically to ensure that the information appearing thereon is of particular interest to the patronage.

In accordance with the present invention, it is anticipated that the disposable news and advertisement dissemination device 100 will also be used as a protective placemat type table setting for restaurant patrons.

When patrons are eating their meals or waiting for their meals to be served, they will be provided targeted information consistent with their demographic profile via the disposable news and advertisement dissemination device 100.

As an advertiser whose advertisement appears in one of the plurality of cells 20 in the first indicia means 16, must pay a fee to appear therein, sufficient revenue is generated to permit a restaurateur to obtain the disposable news and advertisement dissemination device 100 free of charge.

Obtaining the disposable news and advertisement dissemination device 100 free of charge allows restaurateurs to reduce their operating expenses by not having to expend capital to provide each patron a source of news information or expend capital to provide disposable placemat type protective table settings for each patron.

An advantage of the present invention is that it provides a device that will deliver a source of news information to restaurant patrons at no cost to the restaurateur.

Another advantage of the present invention is that it provides a device that will deliver a particular source of news information to a targeted demographic profile.

Another advantage of the present invention is that it provides a disposable device that will deliver news information that is updated periodically.

Yet a further advantage of the present invention is that it provides a device that will reduce the costs of operating a restaurant establishment.

Although the present invention has been described in considerable detail with reference to certain preferred versions thereof, other versions are possible. Therefore, the spirit and scope of the claims should not be limited to the description of the preferred versions contained herein.

What is claimed is:

1. A disposable news and advertisement dissemination device for a food or beverage establishment, comprising:
a disposable sheet material having an upper surface portion and an under surface portion;
a first indicia means and a second indicia means disposed on at least one of the surface portions of the sheet material whereby the first indicia means is disposed along at least one peripheral edge of the sheet material defining a border or partial border for said sheet material and the second indicia means is disposed on at least one of the surface portions of the sheet material so that the second indicia means is adjacent to the border or partial border defined by the first indicia means;
the first indicia means further comprises at least once cell containing advertising information, wherein the advertising information is targeted to a specific demographic profile and is updated periodically; and
the second indicia means further comprises at least one cell containing news information, wherein the news information is targeted to a specific demographic and is updated periodically.

2. The device of claim 1, wherein the specific demographic profile is determined by the characteristics of the food or beverage establishment.

3. The device of claim 2, wherein the disposable sheet material is made of paper.

4. The device of claim 2, wherein the advertising information and the news information is updated monthly.

5. The device of claim 2, wherein the advertising information and the news information is updated bimonthly.

6. The device of claim 2, wherein the advertising information and the news information is updated weekly.

7. The device of claim 2, wherein the advertising information and the news information is updated daily.

8. A method of disseminating news and advertisements to restaurant patrons using the device of claim 2 comprising the steps of:
(a) researching relevant news data that is targeted to a certain demographic profile;
(b) disposing said data upon the second indicia means 18 of the disposable news and advertisement dissemination device 100;
(c) obtaining sponsors to place advertisements within the disposable news and advertisement dissemination device 100;
(d) disposing said advertisements upon the first indicia means 16 of the disposable news and advertisement dissemination device 100;
(e) delivering the disposable news and advertisement dissemination device 100 to a restaurateur; and
(f) placing the disposable news and advertisement dissemination device 100 at each table setting of a food or beverage establishment.

9. An advertising method according to claim 8 wherein an advertiser whose advertisement is disposed along the first indicia means must pay a fee to appear thereon.

10. An advertising method according to claim 9 wherein the restaurant establishment obtaining the disposable news and advertisement dissemination device obtains same free of charge.

11. An advertising method according to claim 9 wherein the restaurant establishment obtaining the disposable news and advertisement dissemination device obtains same for a nominal charge.
